(19) United States
(12) Patent Application Publication
(10) Pub. No.: US 2025/0296050 A1
(43) Pub. Date: Sep. 25, 2025

(54) MEMBRANE MONITORING AND CLEAN-IN-PLACE CONTROL SYSTEMS AND TECHNIQUES

(71) Applicant: Ecolab USA Inc., St. Paul, MN (US)

(72) Inventors: Stephan Dörries, Düsseldorf (DE); Jenny Hicks, St. Paul, MN (US); Ralf Krack, Hilden (DE)

(21) Appl. No.: 19/087,047

(22) Filed: Mar. 21, 2025

Related U.S. Application Data
(60) Provisional application No. 63/569,199, filed on Mar. 24, 2024.

(51) Int. Cl. B01D 65/10; A23L 5/20; B01D 65/02

(52) U.S. Cl. CPC B01D 65/109; A23L 5/20; B01D 65/02; B01D 2321/16; B01D 2321/40

(57) ABSTRACT

A membrane fouling monitoring and analysis system may be used on a food and beverage membrane operated over a plurality of production periods separated by daily clean-in-place cleanings. In some examples, the system receives data indicative of a flow of one or both of a permeate stream and a retentate stream of the membrane during the plurality of production periods and determines a trend of at least one parameter associated with the data to provide a determined trend. The system may compare the determined trend to a baseline fouling trend and determine if and/or when to perform a deep cleaning on the membrane based on comparison. The system may subsequently execute the deep cleaning on the membrane at the scheduled time.

### RELATED APPLICATION

This application claims the benefit of U.S. Provisional Application No. 63/569,199 filed Mar. 24, 2024, the entire contents of which are incorporated herein by reference.

### TECHNICAL FIELD

This disclosure relates to membrane systems and, more particularly, to instrumented monitoring and control systems for membrane systems for managing performance and controlling cleaning operations.

### BACKGROUND

Membrane separation is a technology that selectively separates materials via e.g. pores or semipermeable film and/or minute gaps in the molecular arrangement of a continuous membrane structure. Membrane separations can be classified by pore size and by the separation driving force. Example membrane separation techniques include microfiltration (MF), ultrafiltration (UF), nanofiltration (NF), reverse osmosis (RO) and ion-exchange (IE). In the food, dairy, and beverage industries, various membranes are used to process and purify feed streams to make human-consumable products.

Filtration membranes typically require periodic cleaning to allow for successful industrial application within separation facilities such as those found in the food, dairy, and beverage industries. The membranes can be cleaned by removing foreign material from the surface and body of the membrane and associated equipment. The cleaning procedure for filtration membranes can involve a clean-in-place CIP process where cleaning agents are circulated over and through the membrane to wet, penetrate, dissolve and/or rinse away foreign materials from the membrane. Various parameters that can be manipulated for cleaning typically include time, temperature, mechanical energy, chemical composition, chemical concentration, water type, hydraulic design, and membrane materials of construction.

Filtration membranes used in the food, dairy, and beverage production facilities may be cleaned periodically, such as daily, to ensure that the production line remains clean and sanitary. Even with daily cleaning, fouling can accumulate on a filtration membranes over time as foulant that is not removed through daily cleaning builds up on the membrane. This fouling build up will eventually impact membrane performance and production yield. Tools that would allow an operator to evaluate and control membrane performance and lifecycle would be useful.

### SUMMARY

In general, this disclosure is directed to systems and techniques for monitoring membrane performance and controlling membrane cleaning, membrane replacement, and/or other membrane service actions based on the monitored performance data. The disclosed systems and techniques may be employed in membrane applications where membranes are regularly cleaned (e.g., using a clean-in-place process) but fouling still accumulates over time. In some implementations, one or more key performance indicators associated with membrane production performance are monitored during operation of the membrane The key performance indicators may be associated with a flow of a permeate stream and/or retentate stream generated by a membrane, such as a pressure, time, and/or area normalized flow of permeate and/or retentate through the membrane. In either case, a trend of the monitored performance indicator(s) may be established and extrapolated forward to predict membrane performance at a future date.

The extrapolated fouling trend can be used to predict when production capacity on the membrane is expected to start dropping. As fouling increases on the membrane, the operator may increase the pressure of the feed supplied to the membrane to maintain production capacity (e.g., a certain minimum permeate flow rate and/or certain minimum retentate flow rate). When the system is operating at the maximum feed pressure available for the given membrane system, further fouling may cause production using the membrane to begin dropping (reducing permeate flow rate and/or retentate flow rate), with further dropping subsequently occurring until remediated. Preemptively identifying when this loss of membrane capacity will occur and taking preventative action, e.g., by performing a deep cleaning on the membrane and/or preemptively replacing the membrane, can allow an operator to maintain predictable and economically advantageous production rates.

In some examples, the described systems and techniques can be used to determine if and/or when a deep cleaning should be performed on the membrane. A deep cleaning may be a special clean-in-place cleaning process to remove foulants not removed with daily or other regular clean-in-place cleaning chemistries and/or processes. For example, a determined fouling trend may be extrapolated to a future time and used to determine a predicted time when membrane production is expected to start dropping. From this information, a time for performing a deep cleaning and/or membrane replacement can be determined that includes a time safety margin offset from the predicted time when membrane production is expected to start dropping. The operator and/or software system may schedule and conduct the deep cleaning on the membrane, e.g., prior to the membrane performance deteriorating to a point where there is lost production yield. In this way, the operator may preemptively identify and address membrane performance problems rather than waiting for observed deterioration in production yield to take a corresponding response action.

Membranes used within the various industries may be cleaned more regularly than membranes used in other industries, such as standard water filtration. Within industries such as food and beverage production; biotech production; pharmaceutical production; life sciences; grains, oils, biofuels, and sugars production; and other chemical industries, membranes may need to be cleaned on a regular basis, such as daily, to maintain the performance of the membranes when producing human consumable materials. Systems and techniques according to the disclosure may be used to determine when a deep cleaning that is different than a periodic daily cleaning should be performed the membrane. To do so, some example implementations of disclosed systems and techniques can identify and/or discriminate between performance data associated with active production using the membrane and performance data associated with inactive periods and/or regular (e.g., daily) cleaning periods on the membrane. Analysis of the active production performance data can then be used to predict future overall membrane performance degradation (e.g., notwithstanding ongoing daily cleanings and corresponding daily performance improvements associated with such cleanings) to determine when a deep cleaning should be performed on the membrane.

Monitored data and analysis according to the disclosure can be used to provide a variety of additional insights, allowing one or more corresponding control actions. As one example, one or performance indicators associated with membrane production performance can be monitored and used to evaluate the effectiveness of a periodic (e.g., daily) cleaning performed on the membrane. For example, the production performance of the membrane after one or more daily cleanings can be compared to the production performance of the membrane after one or more other daily cleanings. Based on the comparison, one or more aspects of the daily cleaning may be modified to improve the effectiveness of the daily cleaning (e.g., by modifying a temperature, pressure, flow rate, the chemistry used in the daily cleaning). As another example, one or performance indicators associated with membrane production performance can be monitored and used to determine when the membrane should be replaced. That is, in addition to or in lieu of determining when a deep cleaning should be performed on the membrane, information insights provided by example systems and techniques may indicate when the membrane should be replaced with a new membrane. This allows the operator to order the replacement component and schedule installation while minimizing production downtime.

In one example, a method is described that includes contacting a membrane with a feed stream during each of a plurality of production periods, thereby generating a permeate stream and a retentate stream. The example specifies that feed stream is a human-consumable food or beverage feedstock. The method also includes performing a clean-in-place cleaning of the membrane during each of a plurality of clean-in-place cleaning periods, where each of the plurality of production periods are separated by one of the plurality of clean-in-place cleaning periods. The method also includes receiving, by one or more processors, data indicative of a flow of one or both of the permeate stream and the retentate stream during the plurality of production periods. The method further involves determining, by one or more processors, a trend of at least one parameter indicative of the flow of one or both of the permeate stream and the retentate stream during the plurality of production periods to provide a determined trend. The example method further includes determining, by one or more processors, a time to perform a deep cleaning on the membrane based on the determined trend and subsequently performing the deep cleaning on the membrane.

In another example, a system is described that includes a membrane, a clean-in-place system, one or more sensors, and a controller. The membrane is configured to receive a feed stream that is a human-consumable food or beverage feedstock during each of a plurality of production periods and generate a permeate stream and a retentate stream. The clean-in-place system is operable to perform a clean-in-place cleaning of the membrane during each of a plurality of clean-in-place cleaning periods, where each of the plurality of production periods are separated by one of the plurality of clean-in-place cleaning periods. The one or more sensors are configured to generate data indicative of a flow of one or both of the permeate stream and the retentate stream during the plurality of production periods. The controller is communicatively coupled to the one or more sensors and configured to determine a trend of at least one parameter indicative of the flow of one or both of the permeate stream and the retentate stream during the plurality of production periods to provide a determined trend and determine a time to perform a deep cleaning on the membrane based on the determined trend. In some cases, the system further executes the deep cleaning on the membrane at a scheduled time.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example membrane monitoring and control system.

FIG. 2 is an illustration of an example clean-in-place (“CIP”) equipment arrangement that can be used to perform a periodic clean-in-place cleaning on a membrane in the system of FIG. 1

FIG. 3 is a block flow diagram illustrating an example membrane monitoring and control technique that can be performed according to the disclosure.

FIG. 4 is a plot of example membrane performance data showing an example trend of a parameter indicative of the flow of one or both of a permeate stream and a retentate stream during a plurality of production periods to provide a determined trend.

FIGS. 5A and 5B are plots illustrating the data of FIG. 4 showing example time delays that may be determined and used for executing a deep cleaning before capacity loss of the membrane is predicted to be realized.

FIG. 6 illustrates example pressure and area normalized permeate flow rate data labeled against production time.

### DETAILED DESCRIPTION

This disclosure is generally directed to systems and technique for monitoring the performance of a membrane separation device, using the monitored data to predict future performance degradation of the membrane separation device, and controlling cleaning and/or maintenance actions on the membrane separation device based on the monitored and analyzed data. The membrane separation device may be a reverse osmosis membrane (RO), a nanofiltration membrane (NF), or other type of membrane separation device, such as an ultrafiltration membrane (UF), microfiltration membrane (MF) and/or electrodialysis (ED) membrane. The form of the membrane is not limited, and any type of membrane module may be used such as spiral wound type membrane module, hollow-fiber membrane module, tubular type membrane module, and plane type membrane module or ceramic membranes. Exemplary applications that may use systems and techniques of the disclosure include the food industry, the beverage industry, and the pharmaceutical industry, life science, bio tech, chemical industry.

In some implementations, various parameters relating to the production performance of a membrane separation device may be monitored and analyzed to evaluate the performance of the membrane separation device. For example, one or key performance indicators associated with the production performance of the membrane separation device may be monitored over time. Changes in the one or more key performance indicators over time may indicate an accumulation of fouling on the membrane, a breakdown of the membrane structure, and/or other changes impacting the overall performance of the membrane. The one or key performance indicators can be compared to comparison information to determine if the membrane is performing as expected or, instead, the performance is deteriorating at a different rate than expected according to comparison information. Additional or different comparisons can be performed based on the monitor data, such as comparing membrane performance after one daily cleaning compared to membrane performance after a different daily cleaning to evaluate the effectiveness of the daily cleanings. In any case, based on analysis and/or comparison of monitored performance data, various operational control actions can be taken, such as scheduling and performing a deep clean on the membrane to at least partially restore membrane performance, scheduling and performing a membrane replacement, and/or modifying one or parameters of the daily (or other periodic cleaning) performed on the membrane.

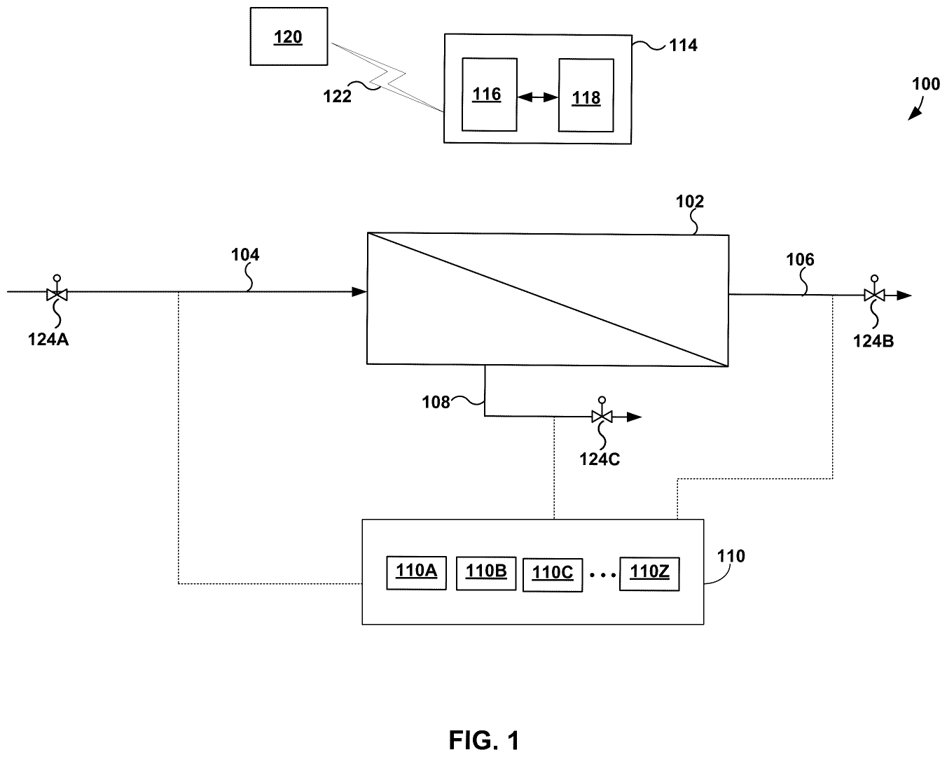

FIG. 1 is a conceptual diagram illustrating an example membrane monitoring and control system 100. System 100 includes a separation membrane 102 that receives a feed stream 104 from a fluid pathway. During operation of system 100, membrane 102 can be contacted with a feed stream liquid to separate the feed stream into different components. For example, a feed stream 104 flowing through the fluid pathway to membrane 102 can contain different product fractions (e.g., different protein fractions in the case of a dairy stream) that are desirably separated into different product streams. Membrane 102 can separate the feed stream into at least a first stream and a second stream, such as a permeate stream 106 and a retentate stream 108 (which may also be referred to as a concentrate stream 108). Upon separation of the feed stream into permeate stream 106 and retentate stream 108, in membrane 102, the permeate stream 106 can contain a substantially lower concentration of larger size molecules as compared to the feed stream. On the other hand, the retentate stream 108 can have a higher concentration of the larger size molecules as compared to the feed stream. In this regard, the permeate stream 106 represents a purified feed stream.

In the illustrated example, one or more sensors 110A-110Z (collectively referred to as sensor 110) can measure one or more characteristics associated with the performance of membrane 102, such as one or more characteristics associated with a flow rate, a temperature, and/or a pressure of one or more of feed stream 104, permeate stream 106, and/or retentate stream 108. Additional characteristics of the one or more streams and/or membrane 102 may be used to evaluate the performance of membrane 10. A controller 114 can be communicatively coupled to various components within membrane separation system 100 to manage the overall system.

For example, controller 114 can be communicatively connected to sensor 110 and optionally any other controllable components or sensors that may be desirably implemented in system 100. Controller 114 can include processor 116 and memory 118. Controller 114 can communicate with controllable components in system 100 via connections. For example, signals generated by sensor 110 may be communicated to controller 114 via a wired or wireless connection. Memory 118 can store software for running controller 114 and may also store data generated or received by processor 116, e.g., from sensor 110. Processor 116 can run software stored in memory 118 to manage the operation of system 100.

As described in greater detail below, controller 114 can analyze data generated by a received from sensor 110 to evaluate the performance of membrane 102. Controller 114 may distinguish between periods when membrane 102 is in active production processing feed stream 104 and periods when membrane is not in active production. Controller 114 may analyze processing performance data associated with the active production period. With reference to comparison information stored in memory 118, controller 114 may determine when a deep clean should be performed on membrane 102 and/or when membrane 102 should be replaced, e.g., to reduce or eliminate future production yield loss associated with reduced membrane performance.

Controller 114 may be implemented using one or more controllers, which may be located at the facility site containing membrane 102. Controller 114 may communicate with one or more remote computing devices 120 via a network 122. For example, controller 114 may communicate with a geographically distributed cloud computing network, which may perform any or all of the functions attributed to controller 114 in this disclosure.

Network 122 can be configured to couple one computing device to another computing device to enable the devices to communicate together. Network 122 may be enabled to employ any form of computer readable media for communicating information from one electronic device to another. Also, network 122 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. Communication links within LANs may include twisted wire pair or coaxial cable, while communication links between networks may utilize analog telephone lines, full or fractional dedicated digital lines, Integrated Services Digital Networks (ISDNs), Digital Subscriber Lines (DSLs), wireless links including cellular and satellite links, or other communications links. Furthermore, remote computers and other related electronic devices may be remotely connected to either LANs or WANs via a modem and temporary telephone link. Communication through network 122 can occur through one or more gateway devices.

System 100 and membrane 102 can be configured for any desired type of membrane separation process, including cross flow separation processes, dead-end flow separation processes, reverse osmosis, ultrafiltration, microfiltration, nanofiltration, electrodialysis, electrodeionization, pervaporation, membrane extraction, membrane distillation, membrane stripping, membrane aeration and the like or combinations thereof. Typically, however, system 100 and membrane 102 may be implemented as a reverse osmosis, ultrafiltration, microfiltration, or nanofiltration membrane separation process.

In most membrane applications, the feed stream is processed under cross flow conditions. When so configured, the feed stream may flow substantially parallel to the membrane surface such that only a portion of the feed stream diffuses through the membrane as permeate. The cross flow rate is typically high in order to provide a scouring action that lessens membrane surface fouling. This can also decrease concentration polarization effects (e.g., concentration of solutes in the reduced-turbulence boundary layer at the membrane surface, which can increase the osmotic pressure at the membrane and thus can reduce permeate flow). The concentration polarization effects can inhibit the feed stream water from passing through the membrane as permeate, thus decreasing the recovery ratio, e.g., the ratio of permeate to applied feed stream. A recycle loop(s) may be employed to maintain a high flow rate across the membrane surface.

System 100 can employ a variety of different types of membranes as membrane 102. Such commercial membrane element types include, without limitation, hollow fiber membrane elements, tubular membrane elements, spiral-wound membrane elements, plate and frame membrane elements, and the like. Typical polymeric materials used to fabricate a membrane element include cellulose acetate and polyamide. Reverse osmosis typically uses spiral wound elements or modules, which are constructed by winding layers of semi-porous membranes with feed spacers and permeate water carriers around a central perforated permeate collection tube. Typically, the modules are sealed with tape and/or fiberglass over-wrap. The resulting construction may have one channel that can receive an inlet flow. The inlet stream flows longitudinally along the membrane module and exits the other end as a concentrate stream. Within the module, water can pass through the semi-porous membrane and is trapped in a permeate channel, which flows to a central collection tube. From this tube it can flow out of a designated channel and is collected.

In different applications, membrane 102 can be implemented using a single membrane element or multiple membrane elements depending on the application. For example, multiple membrane elements may be used forming membrane modules that are stacked together, end to end, with inter-connectors joining the permeate tubes of the first module to the permeate tube of the second module, and so on. These membrane module stacks can be housed in pressure vessels. Within the pressure vessel, the feed stream can pass into the first module in the stack, which removes a portion of the water as permeate water. The concentrate stream from the first membrane can then become the feed stream of the second membrane and so on down the stack. The permeate streams from all of the membranes in the stack can be collected in the joined permeate tubes.

Within most reverse osmosis systems, pressure vessels may be arranged in either “stages” or “passes.” In a staged membrane system, the combined concentrate streams from a bank of pressure vessels can be directed to a second bank of pressure vessels where they become the feed stream for the second stage. Commonly, systems have two to three stages with successively fewer pressure vessels in each stage. For example, a system may contain four pressure vessels in a first stage, the concentrate streams of which feed two pressure vessels in a second stage, the concentrate streams of which in turn feeds one pressure vessel in the third stage. This is designated as a “4:2:1” array. In a staged membrane configuration, the combined permeate streams from all pressure vessels in all stages may be collected and used without further membrane treatment. Multi-stage systems are commonly used when large volumes of purified water are required, for example for boiler feed water. The permeate streams from the membrane system may be further purified by ion exchange or other means.

In a multi-pass system, the permeate streams from each bank of pressure vessels are collected and used as the feed to the subsequent banks of pressure vessels. The concentrate streams from all pressure vessels can be combined without further membrane treatment of each individual stream. Multi-pass systems are typically used when very high purity water is required, for example in the microelectronics or pharmaceutical industries. When system 100 is implemented as a reverse osmosis process, one or more membranes 102 may be configured as a multi-stage and/or multi-pass system.

While system 100 and membrane 102 may be implemented in a cross-flow filtration process, in other configurations, the system may be arranged for conventional filtration of suspended solids by passing the feed stream through a filter media or membrane in a substantially perpendicular direction. This arrangement can create one exit stream (e.g., purified stream 106) during the service cycle. Periodically, the filter may be backwashed by passing a clean fluid in a direction opposite to the feed, generating a backwash effluent containing species that have been retained by the filter. In this arrangement, system 100 may have a feed stream, a purified stream, and a backwash stream. This type of membrane separation is typically referred to as dead-end flow separation and is typically limited to the separation of suspended particles greater than about one micron in size.

Any desired fluid may be supplied as feeds stream 104 to be processed by membrane 102. In some applications, membrane 102 is used to process a liquid food and/or beverage feed stock stream. Example fluids that may be supplied as feed stream 104 to be processed using membrane 102 can include, but are not limited to, dairy products such as raw milk, whole and skimmed milk, condensed milk, cream, whey and whey derivatives, buttermilk, lactose solutions, and lactic acid; protein solutions such as soya protein isolate, soya whey, nutrient yeast and fodder yeast, and whole egg; fruit juices such as orange and other citrus juices, apple juice and other pomaceous juices, red berry juice, coconut milk (e.g., condensed coconut milk), and tropical fruit juices; vegetable juices such as tomato juice, beetroot juice, carrot juice, and grass juice; starch products such as glucose, dextrose, fructose, isomerose, maltose, starch syrup, and dextrine; sugars such as liquid sugar, white refined sugar, sweetwater, and insulin; extracts such as coffee and tea extracts, hop extract, malt extract, yeast extract, pectin, and meat and bone extracts; hydrolyzates such as whey hydrolyzate, soup seasonings, milk hydrolyzate, and protein hydrolyzate; fermented beverages such alcoholic beer and liquor, de-alcoholized beer, and wort; baby food (e.g., infant formula), egg whites, liquid egg, lycene for animal feed, polyols, bean oils, and condensed meat bullion and powders. In different examples, membrane 102 may be a membrane used during milk processing, a membrane used during whey processing, or a membrane used in water polishing.

To evaluate the performance of membrane 102 and to provide data for controlling cleaning and/or maintenance actions, membrane performance may be monitored using one or more sensors 110. A variety of sensors 110 may be implemented in system 100 to provide data indicative of the performance of membrane 102. Example sensors that may be implemented in system 100 include temperature, pressure, and/or flow rate sensors. For example, system 100 may include one or more flow meters to measure a flow rate of feed stream 104, permeate stream 106, and/or retentate stream 108. Instead of measuring flow rate via a flow meter, controller 114 may be communicatively connected to one or more pumps in system 100 and may receive an indication of the flow rate of a particular stream (e.g., feed stream 104) based on an operating rate of a pump providing that stream. Additionally or alternatively, system 100 may include one or more temperature sensors to measure a temperature of feed stream 104, permeate stream 106, and/or retentate stream 108. Still further additionally or alternatively, system 100 may include one or pressure sensors to measure a pressure of feed stream 104, permeate stream 106, and/or retentate stream 108. For instance, one or more sensors 110 may measure a differential pressure across membrane 102 to provide a measured pressure drop across the membrane.

System 100 may include a variety of other sensors in addition to or in lieu of flow rate, pressure, and/or temperature sensor(s). Example types of sensors that may be implemented in system 100 include, but are not limited to, a pH sensor, an oxidation-reduction potential (ORP) sensor, a conductivity sensor, and/or an optical sensor. When used, such sensor(s) may be implemented to measure a correspond characteristic of feed stream 104, permeate stream 106, and/or retentate stream 108.

Each sensor 110 in system 100 can be implemented in a number of different ways in the system. In some examples, a pipe, tube, or other conduit is connected between a fluid pathway through which the stream flows to the sensor, e.g., providing a slip stream or sample stream from the bulk of flowing liquid. As fluid moves through the fluid pathway, a portion of the fluid may enter the conduit and pass adjacent to and/or in contact with sensor 110, thereby allowing the sensor to measure a characteristic of the fluid. In alternative configurations, sensor 110 can be positioned in-line with a fluid pathway, e.g., allowing the sensor to directly sample and/or analyze the stream flowing through the fluid pathway without drawing a slip stream. In still other applications, sensor 110 may be used to analyze a stationary volume of fluid that does not flow through and/or in contact with the sensor. For example, in these alternative configurations, sensor 110 may be implemented as an offline monitoring tool (e.g., as a handheld sensor), that requires filling the sensor with a fluid sample manually extracted from system 100.

FIG. 1 schematically shows sensor 110 in fluid communication with each of feed stream 104, permeate stream 106, and retentate stream 108. In practice, a different sensor 110 (e.g., flow meter, pressure sensor) may be installed to measure a characteristic of each of feed stream 104, permeate stream 106, and/or retentate stream 108. In some configurations, however, a sensor 110 may be in select fluid communication with different streams (e.g., via valves) and placed in selective fluid communication with one of feed stream 104, permeate stream 106, and/or retentate stream 108 at different times to measured a corresponding characteristic of each stream using a single sensor.

In operation, sensors 110 can generate data indicative of one or more characteristics of feed stream 104, permeate stream 106, and/or retentate stream 108. For example, one or more flow sensors can generate data indicative of a flow rate of feed stream 104, permeate stream 106, and/or retentate stream 108. Similarly, one or more pressure sensors can generate data indicative of a pressure of feed stream 104, permeate stream 106, and/or retentate stream 108. Controller 114 can receive data from the sensors deployed throughout system 100 and use data generated by the sensors to determine and/or analyze characteristics associated with a performance of membrane 102. For example, with reference to information stored in memory such as baseline performance information, an area of membrane 102, and/or other information, controller 114 can determine and analyze membrane performance characteristics.

Controller 114 can determine a variety of different membrane performance characteristics based on data received from sensor 110 and/or information stored in memory 118. In some examples, sensor 110 generates data indicative of a flow of permeate stream 106 and/or retentate stream 108. Data indicative of a flow of one or both streams may include flow rate data, total volume data, and/or pressure data associated with one or both streams. Controller 114 can receive the data from sensor 110 and generate or determine one or more performance parameters based on the data.

In some examples, controller 114 can determine a parameter associated with a flow of permeate stream 106 and/or retentate stream 108 by calculating a time normalized flux using Equation (1) below:

$$Time Normalized Stream Flux : \frac{F}{t} \qquad Equation 1$$

In Equation (1) above, F is the total volume of either the permeate or retentate produced by membrane 102 during a production period and t is the total production time over which the volume was produced. Controller 114 can calculate a time normalized flux for both permeate stream 106 and retentate stream 108. In other examples, controller 114 receives time normalized permeate stream 106 and/or retentate stream 108 directly from one or more flow meters which provide data in the formal of a time normalized flow rate.

As another example, controller 114 can determine a parameter associated with a flow of permeate stream 106 and/or retentate stream 108 by calculating a time and area normalized flux using Equation (2) below:

$$Time and Area Normalized Stream Flux : \frac{F}{t \times A} \qquad Equation 2$$

In Equation (2) above, F is the total volume of either permeate or retentate produced by membrane 102 during a production period, t is the total production time over which the volume was produced, and A is the area of membrane 102. An operator can inform controller 114 of the area “A” of a particular membrane, and the information can be stored in and referenced from memory 118. Controller 114 can calculate a time and area normalized flux for both permeate stream 106 and retentate stream 108.

As another example, controller 114 can determine a parameter associated with a flow of permeate stream 106 and/or retentate stream 108 by calculating a time, area, and pressure normalized flux using Equation (3) below:

$$Time , Area , and Pressure Normalized Stream Flux : \frac{F}{t \times A \times p} \qquad Equation 3$$

In Equation (3) above, F is the total volume of either permeate or retentate produced by membrane 102 during a production period, t is the total production time over which the volume was produced, A is the area of membrane 102, and p is the average pressure across membrane 102 during the production period or the average transmembrane pressure per loop during production. Controller 114 can calculate a time, area, and pressure normalized flux for both permeate stream 106 and retentate stream 108.

If loops are operated individually during a production (not all loops are active all time) and added consequently, the active loop time can be multiplied with the surface area of that loops. This additive loop activation area can be used as the (txA) parameter in above formula.

Controller 114 can continuously receive measurements from sensors 110 to generate and/or provide membrane performance parameters associated with the flow of permeate stream 106 and/or retentate stream 108. Alternatively, controller 114 may only receive measurements from sensors 110 associated with periods when membrane 102 is actively processing feed stream 104 to generate permeate stream 106 and retentate stream 108 during production.

To understand different production and non-production phases of operation of membrane 102, it is first useful to describe example operations that may be performed using membrane 102. Membrane 102 can be used to process a feed stream 104 during a production period to generate permeate stream 106 and retentate stream 108. After each production period, the operator of membrane may perform a clean-in-place cleaning of membrane 102. There may be additional phases in which membrane 102 is idling, being rinsed, being replaced, preparing for production, fluid is recirculating through the membrane (by combining the permeate and retentate streams and recycling the combined streams back as the feed stream to the membrane), or otherwise.

Controller 114 may receive data from sensor 110 during production and non-production phases of membrane 102. Controller 114 may segregate data associated with an active production phase of membrane 102 from an inactive non-production phase of membrane 102. Controller 114 can then determine one or more membrane performance parameters associated with a flow of permeate stream 106 and/or retentate stream 108 for the active phase while excluding data associated with the inactive phase. This can help ensure that the performance parameter data determined by controller 114 is appropriately representative of membrane performance during active production and is not misrepresented by sensor data generated during inactive periods.

Controller 114 can determine and distinguish active phases of production on membrane 102 from inactive phases a variety of different ways. The specific way in which controller 114 distinguishes an active from an inactive phase may vary depending on the configuration of the environment in which membrane 102 is implemented in the hardware and software arrangement implemented for controlling membrane 102. For example, controller 114 may receive data from various sensors (e.g., limit switches) and/or production data sources to identify and distinction active from inactive phases.

In some examples, system 100 includes one or more valves 124 controlling the flow of streams to an/or from membrane 102. For example, in the illustrated arrangement, system 100 is illustrated as including a first valve 124A controlling fluid movement of feed stream 104 to membrane 102, a second valve 124B controlling fluid movement of permeate stream 106 from membrane 102, in the third valve 124C controlling fluid movement of retentate stream 108 from membrane 102. Again, system 100 may include a different number or arrangement of valves, and the disclosure is not limited in this respect.

Valves 124 may operate under the control of controller 114 and/or controller 114 may be informed of an opened or closed position of each of the valves (e.g., from limit switches associate with the valves that are communicatively coupled to controller 114). Controller 114 may identify a start of an active phase of production on membrane 102 (and correspondingly a stop of an inactive phase) when both valve 124A controlling the flow of feed stream 104 to membrane 102 is opened and valve 124C controlling the flow of retentate stream 108 from membrane 102 is opened. By contrast, controller 114 may identify a stop of the active phase of production on membrane 102 (and correspondingly the start of an inactive phase) when either or both of valve 124A controlling the flow of feed stream 104 to membrane 102 and/or valve 124C controlling the flow of retentate stream 108 from membrane 102 is closed.

Controller 114 can use data generated by system 100, particularly sensor 110, during the active phase when valves 124A and 124C are opened to calculate performance parameters associated with a flow of permeate stream 106 and/or retentate stream 108. Controller 114 can exclude data associated with the inactive phase, when one or both of valves 124A and 124C are closed, when calculating such performance parameter(s). In this way, controller 114 may discriminate between active phases of production and inactive phases of membrane 102.

In food and beverage applications as well as other applications, membrane 102 may operate over multiple production periods with a clean-in-place period separating each production period. The clean-in-place cleaning period can help temporarily restore membrane production performance (by cleaning some amount of accumulated fouling from the membrane) and can also help ensure the stability of the membrane and products produced there. The duration of each production period and clean-in-place period may vary depending on scheduling at the specific facility where membrane 102 is operated. In some examples, each production period as a duration within a range from two hours to 48 hours, such as from six hours to 36 hours, or from eight hours to 30 hours. In various examples, each production period may have a duration within a range from eight hours to 24 hours, such as from 10 hours to 24 hours, from 12 hours to 24 hours, or from 16 hours to 24 hours. In different examples, reference to a production period of membrane 102 can refer to any period when membrane is receiving feed stream 104 or only active production (e.g., when membrane is receiving feed stream 104 and generating retentate 108).

Each clean-in-place period may have a duration less than 24 hours, such as less than 12 hours, less than eight hours, less than six hours, less than four hours, or less than two hours. In some examples, each clean-in-place period may be a daily clean period performed once per day (once per 24 hour time period). For example, the operator of membrane 102 may operate the membrane substantially continuously, pausing production on a daily basis for a daily clean-in-place cleaning.

In some examples, an operator may conduct a clean-in-place cleaning (which may also be referred to as a clean-in-place event) at least once per 24 hour period, such as twice per 24 hour period. In some examples, an operator may conduct a clean-in-place cleaning/event from 1 to 14 times per week (every 7 days), such as from 3 to 10 times per week. A production period may be executed after every clean-in-place cleaning period.

Controller 114 can determine a trend over time for one or more membrane performance parameters associated with a flow of permeate stream 106 and/or retentate stream 108 (e.g., using measurement data from sensor 110 associated with an active phase while excluding data associated with an inactive phase of membrane 102). This can provide a determined trend for each of the one or more parameters. The period of time over which the determined trend is established may begin when a new membrane 102 is first placed in service and/or following a deep cleaning of membrane 102 as described herein. This is when membrane 102 is least likely to be fouled.

Controller 114 can generate parameter trend information based on sensor information received from sensor 110, e.g., during active and/or inactive production periods. Controller 114 can perform statistical trend analysis on parameter values received and/or calculated by controller 114 identify a determined trend for the one or more parameters.

In some examples, controller 114 may fit a curve to one or more membrane performance parameters associated with a flow of permeate stream 106 and/or retentate stream 108. The curve may correspond to parameter values plotted on a y-axis of a graph with corresponding production time plotted on the x-axis of the graph. In one example, the curve is a first order equation having the form y=mx+b, where y is the performance parameter, x is the time, m is the slope of the curve, and b is the intercept of the curve. The slope of the curve “m” can be stored in a memory associated with controller 114 as a determined trend corresponding to a particular performance parameter. Multiple slope values may be stored corresponding to multiple performance parameters.

In other examples, controller 114 may fit a second or higher order polynomial curve may be fit to the parameter over time. Controller 114 may store coefficients associated with the second or higher order polynomial curve in memory as determine trend values for the curve fit to the parameter data.

In addition to or in lieu of discriminating between active and inactive phases to calculate a determined trend for the membrane performance parameter data, controller 114 may smooth the parameter data and/or raw data from sensor 110 using a statistical smoothing algorithm to remove noise and outliers from the data. Controller 114 may then determine the trend using smoothed parameter values. Subsequent trend analysis may be performed using the smoothed data.

The data set used by controller 114 to determine the trend may be established over a period of operation of membrane 102. For example, the data set used by controller 114 to determine the trend may be data generated by sensor 110 following installation of a clean membrane and initial operational stabilization of the membrane through production (e.g., an initial period of at least 3 days, such as at least 1 week, or at least 2 weeks following installation of a new membrane for stabilization). For example, the data set used by controller 114 to determine the trend may be based on data collected by sensor 110 for a period of at least two weeks, such as at least 1 month, at least 6 weeks, at least 2 months, or at least 3 months. For example, the data set used by controller 114 to determine the trend may be based on data collected by sensor 110 for a period within a range from 1 month to 4 months, such as from 2 months to 4 months.

Controller 114 can determine a time (target date) to take action on membrane 102, such as perform a deep cleaning on the membrane or replace the membrane based on the determined trend corresponding to a particular performance parameter (e.g., based on controller 114 analyzing data defining and forming the trend). In some examples, controller 114 extrapolates the determined trend corresponding to a particular performance parameter to determine a time (target date) to date action on membrane 102, such as perform a deep cleaning on the membrane or replace the membrane.

For example, controller 114 may extrapolate the determined trend for the membrane performance parameter to project how the parameter while change over time in the future. Controller 114 may determine, using the extrapolation, a future time (e.g., a future date) when membrane production is expected to start dropping. The future time when membrane production is expected to start dropping can correspond to a future time when the feed stream is supplied to membrane 102 at the maximum available pressure (e.g., based on the pumping capacity for the facility where membrane 102 is located) yet the volume of permeate and/or retentate produced by membrane 102 starts decreasing. This can indicate that fouling on membrane 102 has reached a point where, even under maximum pumping pressure, production is reduced compared to the permeate and/or retentate volume previously produced (e.g., steady state production volumes) without being pressure or fouling limited.

Controller 114 can use a variety of different extrapolation techniques to extrapolate the determined trend (e.g., data forming the trend) to project how the trended membrane performance parameter is expected to change with time looking into the future. In one example, controller 114 may use linear extrapolation, which uses a linear equation to predict future values for the performance parameter. In another example, controller 114 may use polynomial extrapolation, which uses a polynomial equation to predict future values for the performance parameter. As another example, controller 114 may use a Bayesian extrapolation technique to predict future values for the performance parameter. Controller 114 can use a neural network or other machine learning technique to learn complex patterns from performance parameter data and that can be used to make extrapolated predictions about new values for the performance parameter outside the range of the training data.

Controller 114 can determine a time (target date) to take action on membrane 102, such as perform a deep cleaning on the membrane or replace the membrane, based on the extrapolation of the determined trend (e.g., extrapolation of the data forming the trend) with reference to reference data stored in memory 118. In practice, historical membrane performance data with corresponding production capacity information may be generated, analyzed, and/or stored to determine the time to take action on membrane 102. For example, reference data may be generated based on historical membrane performance data and corresponding production capacity data from the same type of membrane as membrane 102 currently being monitored by sensor 110 and/or from the same facility where membrane 102 currently being monitored by sensor 110 is located. The reference data may be stored in memory 118 and relate different values of the membrane performance parameter(s) being determined for membrane 102 to corresponding membrane production capacity data. With reference to stored reference data based on this historical information, controller 114 can determine a time (target date) to take action on membrane 102, such as perform a deep cleaning on the membrane or replace the membrane, by at least in part by determining a predicated date when the extrapolated trend of the performance data is associated with membrane production starting to drop. Information relating different membrane performance parameter values to membrane production values can be stored in the form of an equation, table, and/or other parameters.

Controller 114 may determine the time (target date) to take action on membrane 102, such as perform a deep cleaning on the membrane or replace the membrane, as the date when the predicated date when membrane production is expected to start dropping. Alternatively, controller 114 may apply a time safety margin offset to the predicted date, thereby building in a margin of days or weeks when action should be taken before membrane production is expected to begin dropping. The magnitude of the time safety margin offset applied by controller 114 may depend on various factors, such as how aggressively the operator desires to operate the membrane up to expected production drop. In various examples, the time safety margin offset may be at least 3 days, such as at least 1 week, at least 2 weeks, at least 3 weeks, at least 4 weeks, or at least 6 weeks. In some examples, the time safety margin is within a range from 1 week to 6 weeks, such as from 2 weeks to 4 weeks, although other time safety margin values can be used.

In response to controller 114 determining a time to perform a deep cleaning on membrane 102, the deep cleaning may be scheduled and/or executed under the control of controller 114. Controller 114 can control valves, pumps, and/or other controllable features in system 100 to execute a deep cleaning on membrane 102, introducing a deep cleaning chemical agent to membrane 102 during a deep cleaning event, and/or controlling other clean-in-place cleaning steps to execute the deep cleaning.

While a deep cleaning is described as being performed by controller 114, it should be appreciated that operator intervention may or may not be needed to perform some or all of the actions. For example, in practice, controller 114 may issue a user alert (e.g., visual text and/or graphics) on a computer user interface providing control instructions and/or a recommended course of action for addressing monitoring membrane performance conditions. An operator may interact with plant equipment—either manually or through a controller interface (e.g., computer) controlling the plant equipment—to implement the desired actions, such as perform a deep clean and/or replace membrane 102.

In general, a deep cleaning performed on membrane 102 refers to a special clean-in-place cleaning procedure applied to remove specific foulant(s) and/or to recover membranes capacity. A deep cleaning may take longer and/or involve more steps compared to a regular (e.g., daily) clean-in-place cleaning. For example, the deep cleaning may involve one or more steps taking at least 30 minutes to execute and include a separate rinse step.

A deep cleaning may utilize more water, energy, and/or clean-in-place cleaning agents compared to what is used in a regular (e.g., daily) clean-in-place cleaning. A deep cleaning may include additional or different chemistries than the regular (e.g., daily) clean-in-place cleaning to help remove foulants the regular (e.g., daily) clean-in-place cannot suitably tackle. This may include different substances with different cleaning mechanisms (e.g., enzymes that are catalyst to break down soils, oxidative cleaners to break down soil by oxidation), and/or higher concentrations of agents (e.g., surfactants, enzymes) compared to the regular (e.g., daily) clean-in-place cleaning.

Example agents that may be used during a deep cleaning can include enzymes such as lipase (e.g., to break down high melting fats which, since these enzymes are difficult to inactivate a longer inactivation procedure makes the CIP long); amylases, cellulases etc. (e.g., to remove starch and matrixes); and/or proteases. Example deep cleaning agents and techniques that may be used are described in “MULTI-STEP METHODS OF CLEANING DAIRY MEMBRANES,” assigned attorney docket number P11880USP1 and filed October 2023, the entire contents of which are incorporated herein by reference.

In addition to or in lieu of determining when to perform a deep cleaning on membrane 102 and/or to replace the membrane, controller 114 may evaluate a quality of a periodic (e.g., daily) clean-in-place cleaning performed on membrane 102 based on data generated by sensor 110. The determined quality of cleaning may be used to determine whether to modify one or more process parameters or chemistries used in the periodic clean-in-place cleaning.

For example, controller 114 may determine a trend of at least one parameter indicative of the flow of one or both of the permeate stream and the retentate stream, as discussed above, over different production periods following different clean-in-place cleaning periods. For example, controller 114 may determine a trend of one or more performance parameters over one or more prior production periods to provide the determined trend. This can provide a baseline trend of the one or more parameters. Controller 114 may then determine the trend for the one or more performance parameters over a new production period that follows a clean-in-place cleaning period (a clean-in-place cleaning event) to provide a post-cleaning trend. The post-cleaning trend maybe generated based on data from sensor 110 following the clean-in-place cleaning period/event.

Controller 114 can compare the post-cleaning trend of the parameter to the determined trend (e.g., baseline trend) for the parameter, which represents the trend prior to the clean-in-place cleaning event. Controller 114 can determine a quality of a clean-in-place cleaning associated with the clean-in-place cleaning period based on the comparison of the post-cleaning trend to the determined/baseline trend established prior to the clean-in-place cleaning event. The post-cleaning trend and the determined trend for one or more production periods prior to the clean-in-place event can be stored in the form of an equation, table, and/or parameters. For example, trends can be stored in the form of parameters for a curve fit to trend data (e.g., slope and intercept).

Controller 114 can compare the post-cleaning trend associated with each of one or more membrane performance parameters with determined trend information corresponding to the period prior to the clean-in-place cleaning event a variety of different ways. Controller 114 may perform the comparison by comparing one or more coefficients for the curve defining the post-cleaning trend associated with each of one or more membrane performance parameters with one or more corresponding coefficients defining the curve for the determined trend for the period prior to the clean-in-place cleaning event. For example, controller 114 may compare the slope of the curve defining the post-cleaning trend associated with a membrane performance parameter with a corresponding slope defining the curve for the determined trend for one or more periods prior to the clean-in-place cleaning event.

Controller 114 can determine a quality of a clean-in-place cleaning event based on comparison of the post-cleaning trend with the determined trend corresponding to the period prior to the clean-in-place cleaning event. For example, controller 114 may determine that an unsatisfactory clean-in-place cleaning event occurred when the post-cleaning trend differed from the determined trend by more than a threshold amount. In various examples, the threshold amount may be a difference between the post-cleaning trend and the determined trend (e.g., a difference between the slope of the post-cleaning trend and the slope of the determined trend) greater than or equal to 5% of the determined trend (e.g., slope of the determined trend), such as greater than or equal to 10% of the determined trend, greater than or equal to 25% of the determined trend, or greater than or equal to 50% of the determined trend. For example, the threshold amount may range from 5 percent to 25 percent of the determined trend (e.g., slope of associated with the determined trend).

Various parameters of the periodic (e.g., daily) clean-in-place cleaning may be modified in response to determining that the clean-in-place cleaning event provided an unsatisfactory quality of cleaning. In some examples, one or more process parameters (e.g., temperature, pressure, duration) is modified for subsequent clean-in-place cleanings (e.g., by controller 114). Additionally or alternatively, an operator may modify or switch one or more chemistries to be used in subsequent clean-in-place cleanings.

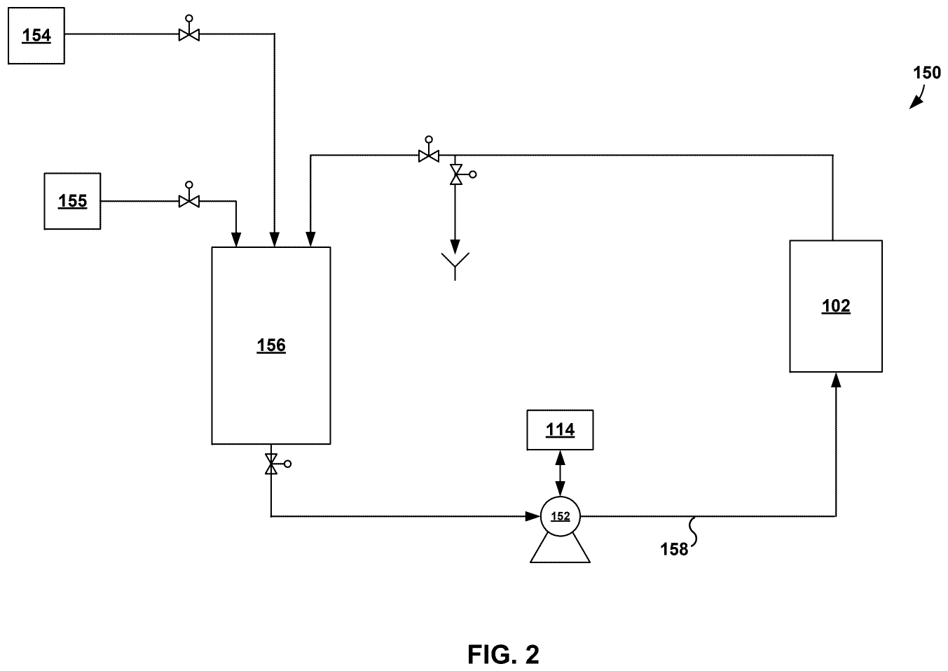

As briefly discussed above, a deep cleaning performed on membrane 102 can be distinguishable from a periodic (e.g., daily) clean-in-place cleaning that can be performed on the membrane. FIG. 2 is an illustration of an example clean-in-place (“CIP”) equipment arrangement 150 that can be used to perform a periodic clean-in-place cleaning on membrane 102. Equipment arrangement 150 includes a pump 152 fluidly connected to a supply source of water 154. The water can be delivered to a tank 156 that fills with the water and provides a reservoir of fluid from which pump 152 can draw. One or more sources of cleaning agents 155 can provide one or more cleaning agents that also supplied to tank 156, e.g., to intermix with the water and generate a cleaning fluid.

During operation, pump 152 can draw fluid at a suction side of the pump, pressurize the fluid inside of the pump, and discharge the fluid at an elevated pressure into fluid conduit 158 fluidly connected to membrane 102. Inside of membrane 102, the pressurized fluid can contact surfaces of the membrane, e.g., for flushing soil from the surfaces, chemically cleaning the surfaces, and/or flushing residual cleaning fluid from the surfaces. Residual fluid having passed through the membrane 102 can discharge through a permeate stream fluid outlet and/or a retentate fluid outlet. Fluid exiting membrane 102 during a CIP process can either be returned to tank 156 (or a different tank) for recirculation or be disposed of to drain.

CIP equipment arrangement 150 in FIG. 2 is illustrated as including an assortment of valves and fluid conduits that control fluid movement through the system. Controller 114 can manage the overall operation of CIP system 150. For example, controller 114 may electronically actuate valves to open/close the valves and control pump 152 to control fluid movement through the system.

Controller 114 can control system 150 to execute and control the various steps of the CIP process, including generating one or more fluids during the CIP process and controlling the timing and delivery of the fluid(s). While process steps of CIP system 150 are described as being executed by controller 114 herein, it should be appreciated that one or more (e.g., all) actions described as being executed by controller 114 may be executed by a human operator (e.g., manually turning valves and/or turning pump 152 on and off) without departing from the scope of the disclosure.

Although FIG. 2 illustrates one particular arrangement of a CIP system, it should be understood that this is only one example. The disclosure is not limited to a CIP system having any particular configuration, much less the particular configuration of FIG. 2. In different examples, CIP system 150 may not include tank 156 or may include multiple tanks, e.g., where one tank holds a pre-rinse and/or rinse fluid and a separate tank holds a cleaning fluid. Additionally or alternatively, CIP system 150 may include a recirculation and/or recovery tank different from tank 156. For example, tank 156 may be a fresh or new liquid tank whereas a recovery tank may be used to recover liquid after having passed through membrane 102, e.g., for recirculation and/or use as a pre-rinse fluid in a subsequent cycle of CIP cleaning. As yet another example, CIP system 150 may include a heat exchanger, heater, and/or cooler to adjust the temperature of fluids used during the CIP process. CIP system 150 can include additional or different features, as will be appreciated by those of ordinary skill in the art.

For example, during one or more steps of the CIP process (e.g., cleaning step), the fluid passing through the CIP system may be heated above ambient temperature. For example, the fluid may be heated to a temperature ranging from 45 degrees Celsius to 90 degrees Celsius, such as from 50 degrees Celsius to 75 degrees Celsius. Other heating temperatures may be used or CIP system 150 may not deliberately heat the fluid used during the CIP process.

In general, membrane 102 can be cleaned in place (e.g., without disconnecting the equipment from the fluid connections it has during typical operation) using CIP arrangement 150. The CIP process performed by CIP arrangement 150 can be accomplished by passing fluid through membrane 102. While mechanical scrubbing can also be performed, typically CIP is performed without mechanical action or contact with the internal surfaces of the equipment being cleaned (e.g., membrane 102) during CIP processes, and only fluid contact. In either case, executing under the control of controller 114, the CIP system may perform a multistep cleaning process that involves passing multiple different fluids through membrane 102 and fluidly connected piping to arrive at a resultant clean state. For example, the CIP system may execute a cleaning process that initially utilizes a pre-rinse fluid followed by a cleaning fluid and further followed by a rinse fluid.

Pre-rinse fluid may be a fluid that functions to rinse soil from within membrane 102 and associated piping, helping to eliminate soil residues within the equipment and prepare the equipment for subsequent flushing with a cleaning fluid. Pre-rinse fluid is typically water (e.g., may consist or consist essentially of water), although may include pretreatment additives. Example pretreatment fluids are described in US Patent Publication No. 2008/0105279, titled “Methods for Cleaning Industrial Equipment with Pre-Treatment,” which is assigned to the same assignee as the present application and the entire contents of which are incorporated herein by reference for all purposes.

In some examples, pre-rinse fluid is passed through membrane 102 and associated piping only a single time before being discarded to drain via a conduit. In other examples, the pre-rinse fluid is recirculated through the CIP system so the fluid passes through tank 156 (or a different tank), pump 152, and membrane 102 and associated piping multiple times. During each successive pass through the industrial equipment, the pre-rinse fluid may release more soil from the industrial equipment. Recirculating pre-rinse fluid through membrane 102 and associated piping can help conserve the amount of fluid consumed during the pre-rinse step. Independent of whether the pre-rinse fluid is recirculated through membrane 102 and associated piping or passed through the equipment only a single time, the fluid may be discarded to drain at the end of the pre-flushing step.

Cleaning fluid used to clean membrane 102 and associated piping during a CIP cleaning step can be generated from water source 154 and one or more concentrated chemical agents 155. Under the control of controller 114, water can be supplied to tank 156 and combined with one or more chemical agents 155 to generate a cleaning fluid.

For example, operating under the control of controller 114, a target amount of one or more concentrated chemical agents 155 can be dispensed into tank 156 along with a target amount of water to generate a dilute cleaning fluid that is flushed through membrane 102 and associated piping. Example chemical agents 155 that can be used during the CIP process can include, but are not limited to, an alkaline source (e.g., sodium hydroxide, potassium hydroxide), triethanol amine, diethanol amine, monoethanol amine, sodium carbonate, morpholine, sodium metasilicate, potassium silicate, an acidic source, such as a mineral acid (e.g., phosphoric acid, sulfuric acid) and/or an organic acid (e.g., lactic acid, acetic acid, hydroxyacetic acid, citric acid, glutamic acid, glutaric acid, gluconic acid). In addition, although the CIP system in FIG. 2 is illustrated as only having a single concentrated chemical, in other examples, the system may include multiple concentrated chemicals that are used either alone or in combination.

For example, the CIP system may perform multiple cleaning phases that include an alkaline wash and an acid wash. During the alkaline wash, controller 114 may combine one or more concentrated chemical agents with water in tank 156 to generate an alkaline detergent. Controller 114 can control pump 156 to pass the alkaline detergent through membrane 102 and associated piping. The alkaline detergent may help dissolve fat, proteins, and hard deposits, among other components. An intermediate water rinse may or may not be performed on the equipment after the alkaline detergent wash by controller 114. In either case, controller 114 may combine one or more concentrated chemical agents water in tank 156 to generate an acidic detergent. Controller 114 can control pump 152 to pass the acidic detergent through membrane 102 and associated piping. The acidic detergent may remove mineral deposits from the equipment and neutralize remaining alkaline detergent on the surfaces of the equipment.

Independent of the number of different cleaning phases using different cleaning agents performed during the CIP cleaning step, each cleaning fluid may be passed through membrane 102 and associated piping only a single time before being discarded to drain via conduit or may be passed through the industrial equipment multiple times. For example, the cleaning fluid may be recirculated through CIP system so the fluid passes through tank 156 (or a different tank), pump 152, and membrane 102 and associated piping multiple times. During each successive pass through membrane 102 and associated piping, the cleaning fluid may release more soil from the industrial equipment. Recirculating cleaning fluid through membrane 102 and associated piping can help conserve the amount of fluid consumed during cleaning. Independent of whether the cleaning fluid is recirculated through membrane 102 and associated piping or passed through the equipment only a single time, the fluid may be discarded to drain at the end of the cleaning step.

Rinse fluid used in in the CIP system is typically water (e.g., may consist or consist essentially of water), although may include additives and/or other fluids can be used as a rinse fluid. In still other examples, product to be processed using membrane 102 is passed through membrane 102 and associated piping following a CIP cleaning step and the product initially passed through the equipment (which may pick up residual chemical agent) is discarded.

Independent of the specific type of rinse fluid used, following a cleaning step of a CIP process, the rinse fluid can be passed through membrane 102 and associated piping to flush the equipment of any residual chemical agent remaining in the equipment. This can prepare the membrane to again process product.

In general, fluid used during the CIP process (e.g., pre-rinse fluid, cleaning fluid, rinse fluid) are liquid-phase fluids. However, one or more of the fluids may be a gas-phase fluid or include both liquid and gas phases. For example, a fluid used during the CIP process may be heated to generate a gas phase (e.g., steam) that is passed through membrane 102 and associated piping. Example multiphase CIP treatment techniques that can be performed are described in US Patent Publication No. 2005/0183744, titled “Method for Treating CIP Equipment and Equipment for Treating CIP Equipment,” which is assigned to the same assignee as the present application and the entire contents of which are incorporated herein by reference.

In the above-described manner, controller 114 may control CIP arrangement 150 to perform a series of cleaning steps to clean membrane 102 and associated piping without disassembling or removing the membrane from its location of normal operation. It should be appreciated, however, that the foregoing description of a CIP cleaning process is merely one example and different CIP cleaning processes may be used. For instance, in some applications, the rinse step is omitted from the CIP cleaning process, e.g., to prevent contamination of the equipment with bacteria following the cleaning step.

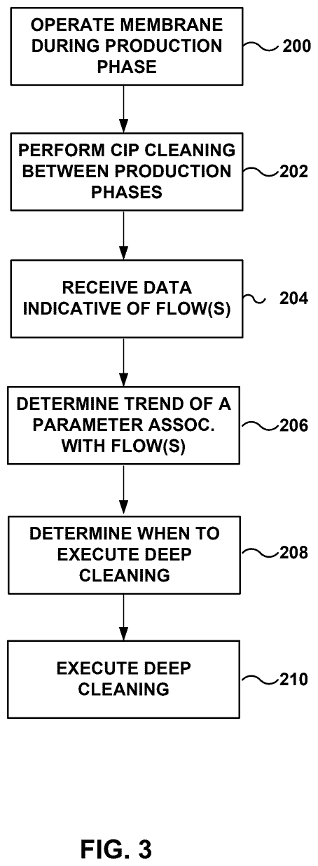

FIG. 3 is a block flow diagram illustrating an example membrane monitoring and control technique that can be performed according to the disclosure. The example technique of FIG. 3 will be descried with reference to system 100 in FIG. 1 discussed above although can be performed on membrane systems consistent with the disclosure.

The example technique of FIG. 3 involves contacting the membrane 102 with the feed stream 104 during a plurality of production periods to generate permeate stream 106 and retentate stream 108 (step 200). During each production period may be characterize by an active phase in which the feed stream valve 124A, permeate valve 124B (when included), and retentate valve 124C are opened. Each production period may or may not have been in active phase where membrane 102 is being prepared for active production, recycle flow is being passed through the membrane, and/or other activity is occurring with the membrane that does not result in concurrent production of permeate stream 106 and retentate stream 108 for intended downstream application. The duration of each of the plurality of production periods may be the same, or one or more production periods may have a different duration than one or more other production periods. Controller 114 may control one or more pumps, valves, and/or other controllable components in system 100 to control the delivery of feed stream 104 to membrane 102 to generate permeate stream 106 and retentate stream 108.

The example technique of FIG. 3 also includes performing a clean-in-place cleaning of membrane 102 during each of a plurality of clean-in-place cleaning periods (step 202). Each of the plurality of production periods can be separated by one of the plurality of clean-in-place cleaning periods. For example, a daily or other periodic clean in-place cleaning may be performed on membrane 102, thereby establishing a temporal and operational separation between one production period using membrane 102 and a subsequent production period. The duration of each clean-in-place cleaning period can include the time during which delivery of feed stream 104 is suspended to membrane 102 and, instead, the membrane is prepared to receive or is receiving a pre-rinse fluid, a cleaning fluid, and/or a post-rinse fluid. Controller 114 may control one or more pumps, valves, and/or other controllable components in CIP assembly 150 (FIG. 2) to perform a daily or other periodic clean-in-place cleaning of membrane 102. Each clean-in-place cleaning may remove some but not all foulant buildup on membrane 102. As a result, an amount of foulant buildup one membrane 102 can increase over time notwithstanding periodic clean-in-place cleanings.

With further reference to FIG. 3, the example technique further includes controller 114 receiving data from sensor 110 indicative of a flow of one or both of permeate stream 106 and retentate stream 108 during each of the plurality of production periods (step 204). In some examples, sensor 110 includes a first flow sensor measuring a flow of permeate stream 106 and a second flow sensor measuring a flow of retentate stream 108. Additionally or alternatively, sensor 110 may directly or indirectly measure a total volume of permeate and/or retentate produced during each of the plurality of production periods.

Controller 114 can determine a trend of at least one parameter indicative of the flow of one or both of permeate stream 106 and retentate stream 108 during the plurality of production periods to provide a determined trend (step 208). In various example applications, controller 114 may calculate values for one or more select parameter(s) to be trended based on data received from sensor 110. Example parameter(s) that may be calculated by controller 114 based on received data include, but are not limited to, a time-averaged permeate flow rate, a time-averaged retentate flow rate, a pressure and area-normalized permeate flow, a pressure and area-normalized retentate flow, an area normalized permeate flow, and an area normalized retentate flow.

In some examples, a time-averaged permeate flow rate and/or a time-averaged retentate flow rate may be provided directly from a flow rate sensor without further calculation by controller 114. In some examples, controller 114 receives data indicative of a total volume of permeate and/or retentate produced over each of the plurality of production periods and calculates one or more parameters based on the production time for each of the plurality of production periods over which the permeate and/or retentate was produced. For example, controller 114 may integrate a magnitude of data indicative of flow during each of the plurality of production periods over time. For example, controller 114 may integrate a magnitude of the volume of permeate and/or retentate produced by membrane 102 over the production time during which the permeate and/or retentate was produced. Controller 114 may calculate one or more parameters associated with the flow of the permeate and/or retentate for each production period (e.g., multiple times associated with each production period to provide multiple values associated with that production period), with different values being calculated for different production periods corresponding to changing data for each production period.

Controller 114 may receive data indicative of the flow of one or both of permeate stream 106 and retentate stream 108 during both an active phase of each of the plurality of production periods and an inactive phase of each of the plurality of production periods. Controller 114 can discriminate between the active phase and inactive phase to calculate parameter values and/or trend data associated with the active phase but not the inactive phase. For example, controller 114 may distinguish in active phase as one in which feed stream valve 124A and retentate valve 124C are opened the from an inactive phase as one in which one or both of which feed stream valve 124A and retentate valve 124C are closed. Controller 114 may determine the trend of the one or more parameters indicative of the flow of one or both of permeate stream 106 and retentate stream 108 during the plurality of production periods using data associated with the active phase of production and excluding data associated with the inactive phase of production.

In some examples, controller 114 determines a trend of one or more parameters indicative of the flow of one or both of permeate stream 106 and retentate stream 108 during the plurality of production periods by fitting a curve to a calculated or determined parameter over time for the plurality of production periods. For example, controller 114 can calculate values for one or more of a time-averaged permeate flow rate, a time-averaged retentate flow rate, a pressure and area-normalized permeate flow, a pressure and area-normalized retentate flow, an area normalized permeate flow, and an area normalized retentate flow for membrane 102 over multiple production periods. Controller 114 may calculate values using data associated with active phases of production, excluding data associated with inactive phases of production. Controller 114 may then fit a single or higher order curve to the calculated or determined values over time to provide a determined trend have associated coefficients (e.g., slope and intercept coefficients).

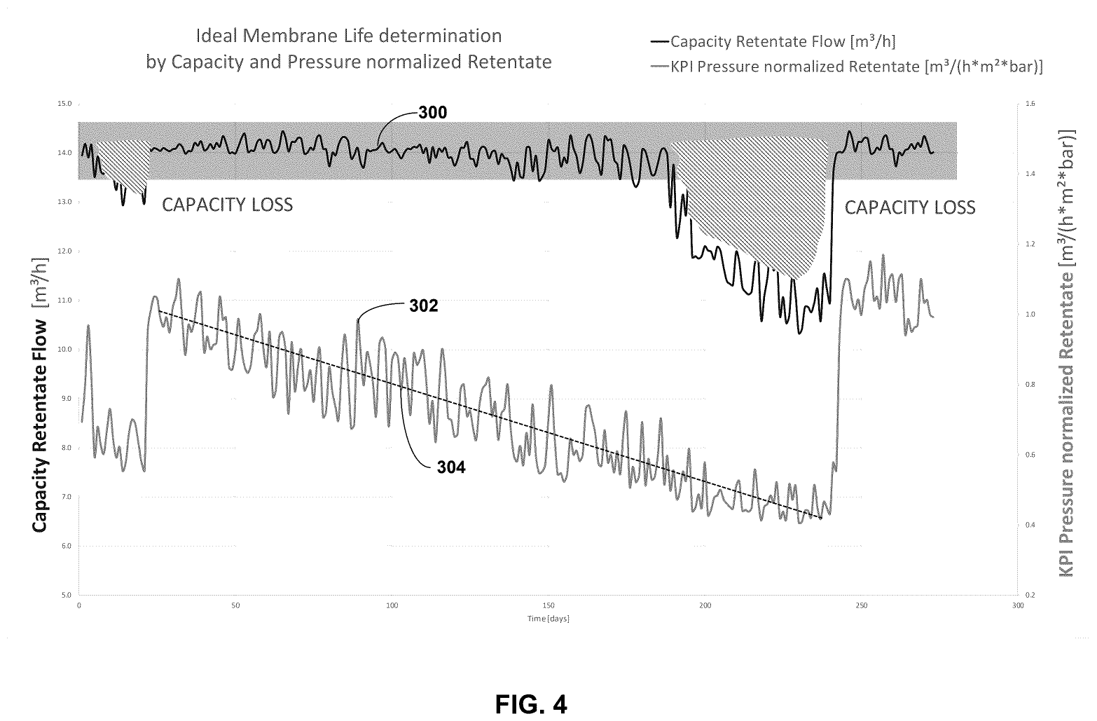

FIG. 4 is a plot of example membrane performance data showing an example trend of a parameter indicative of the flow of one or both of permeate stream 106 and retentate stream 108 during a plurality of production periods to provide a determined trend. FIG. 4 illustrates example retentate flow rate 300 labeled on the left-side Y-axis plotted against production time on the X-axis. FIG. 4 also illustrates pressure and area normalized retentate flow rate 302 labeled on the right-side Y-axis plotted against production time on the X-axis. The example data illustrate how the example membrane maintains a substantially constant retentate flow 300 until capacity loss is observed. In practice, an operator may activate loops earlier and/or increase the pressure of a feed pump delivering feed stream 104 to membrane 102 to maintain substantially constant production until maximum driving pressure is reached, at which point membrane capacity and corresponding yield decline precipitously. By normalizing the retentate flow rate by pressure, e.g., to provide pressure and area normalized retentate flow rate 302, the true declining capacity of membrane over time is observed. Each production period is characterized by a spike in the data (corresponding to a completed daily or other periodic clean-in-place cleaning boosting membrane performance) that then degrades to a trough (leading to another clean-in-place cleaning period). In the example data, a trend line 304 is fitted to the pressure and area normalized retentate flow rate 302. The example data illustrates a first order curve having corresponding slope and intercept values.

With further reference to FIG. 3, the example technique involves controller 114 determining when to execute a deep cleaning (or take other action) based on the determined trend (step 208). For example, controller 114 may project or extrapolate the determined trend forward in time to determine when fouling will reach a level resulting in capacity loss of membrane 102 (reduced permeate and/or retentate production). In some examples, controller 114 may project or extrapolate the determined trend forward in time to determine a date at which the trended parameter will reach a level corresponding to capacity loss of membrane 102. Controller 114 can compare the trended parameter to stored information indicating a value for the parameter corresponding to capacity loss of membrane 102.

Controller 114 may determine, using the extrapolation, a future time (e.g., a future date) when membrane production is expected to start dropping. The future time when membrane production is expected to start dropping can correspond to a future time when the feed stream is supplied to membrane 102 at the maximum available pressure (e.g., based on the pumping capacity for the facility where membrane 102 is located) yet the volume of permeate and/or retentate produced by membrane 102 starts decreasing. Controller 114 can determine a time (target date) to take action on membrane 102, such as perform a deep cleaning on the membrane or replace the membrane, based on the extrapolation of the determined trend (e.g., extrapolation of the data forming the trend) with reference to reference data stored in memory 118. The reference data may be generated based on historical membrane performance data and corresponding production capacity data.

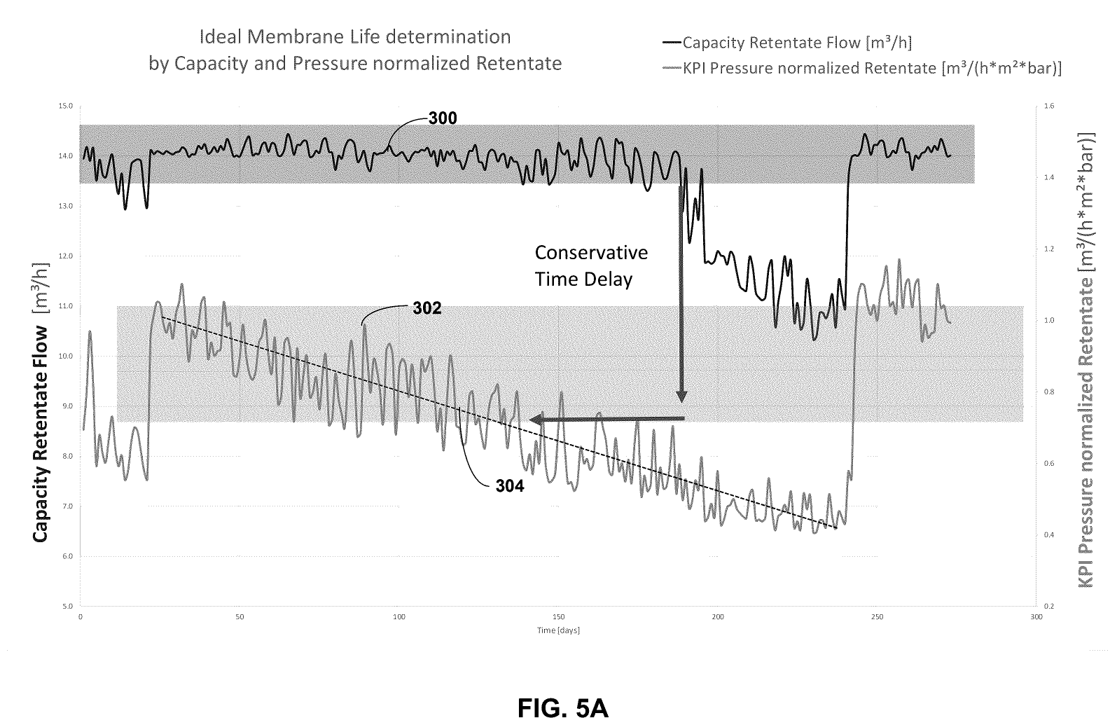

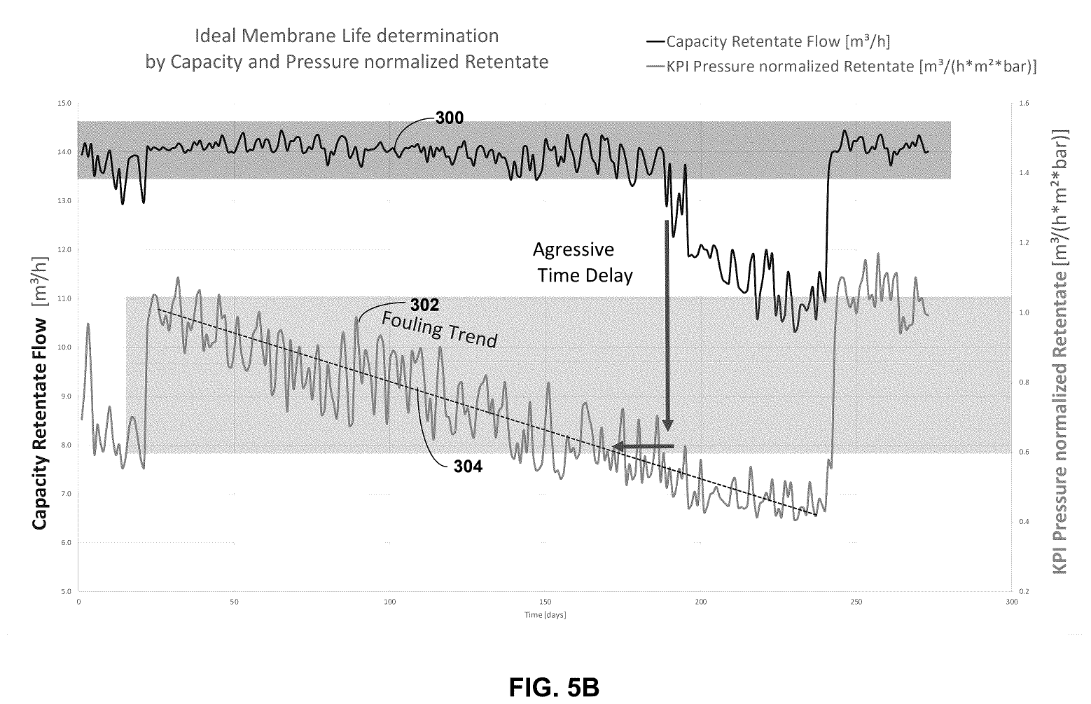

Controller 114 may establish a time for performing the deep cleaning on membrane 102 at or immediately before capacity loss of membrane 102 is predicted to be realized. Alternatively, a time safety margin offset may be input into a memory associated controller 114 and used to determine a time for performing a deep cleaning of membrane 102 that includes a time safety margin before capacity loss of membrane 102 is predicted to be realized. FIGS. 5A and 5B are plots illustrating the data of FIG. 4 showing example time safety offsets that may be determined and used for executing a deep cleaning before capacity loss of membrane 102 is predicted to be realized. FIG. 5A illustrates an example conservative time delay that includes an extra margin of days between executing a deep cleaning and when capacity loss of membrane 102 is predicted to be realized. FIG. 5B illustrates an example aggressive time delay that includes lesser number of days between executing a deep cleaning and when capacity loss of membrane 102 is predicted to be realized.

With further reference to FIG. 3, the example technique includes performing a deep cleaning on membrane 102 based on comparison of the determined trend to the baseline fouling trend (step 210). A deep cleaning can be scheduled for a number of days corresponding to a time safety margin before capacity loss is expected to be realized. Operating under the controller of controller 114, system 100 may execute the deep cleaning of membrane 102 when scheduled.

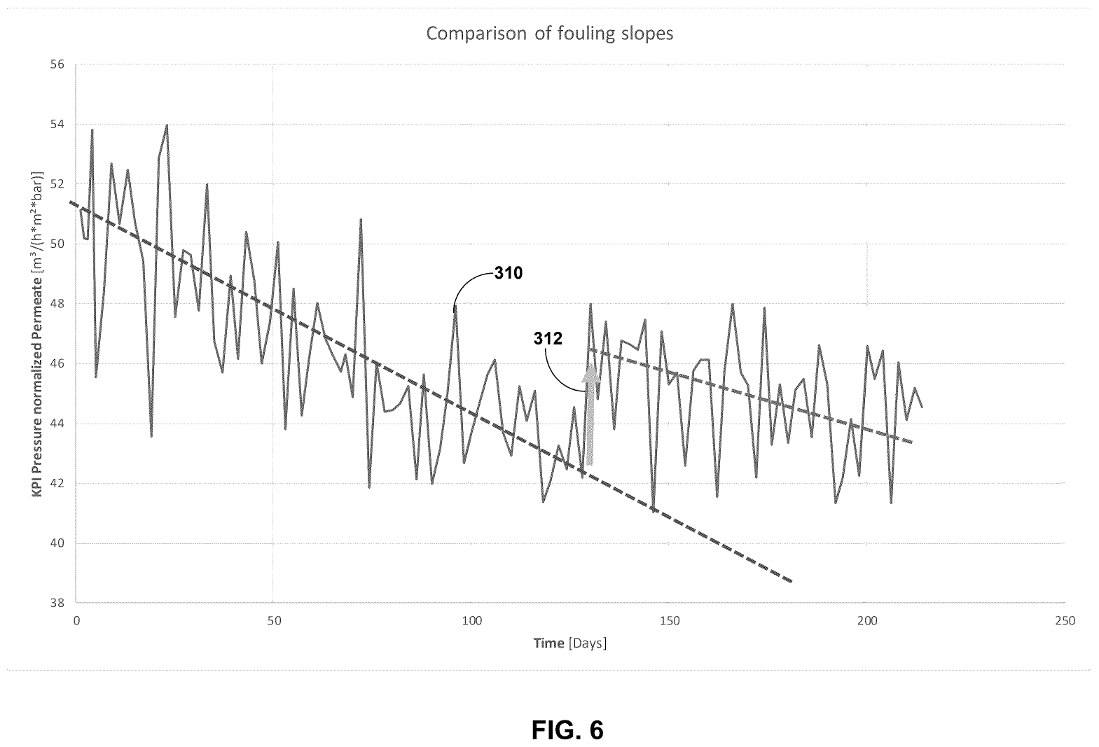

FIG. 6 illustrates example pressure and area normalized permeate flow rate data 310 labeled on the left-side Y-axis plotted against production time on the X-axis. The example data illustrate a decreasing trend corresponding to increased fouling of the membrane until a deep cleaning indicated by arrow 312 is performed on the membrane. The deep cleaning restores production performance for the membrane, albeit to lower level than when the membrane was newly installed. As shown by the example data, after deep cleaning 312, alternative clean-in-place cleaning parameters (e.g., alternative chemistry used during clean-in-place cleaning) may be implemented to decrease the rate of fouling after the deep cleaning as compared to before the deep cleaning. Thus, the data show the example impact of both a deep cleaning and a change in clean-in-place cleaning chemistry at restoring and extending the performance and service life of the membrane.

While the foregoing discussion has focused on determining if and/or when to execute a deep cleaning on a membrane (e.g., membrane 102), systems and techniques of the disclosure may additionally or alternatively be implemented to monitor, control, and/or modify periodic clean-in-place cleanings of the membrane. For example, controller 114 can determine a trend of data indicative of a flow of one or both of permeate stream 106 and retentate stream 108 over one production period to provide a determined trend for that production period. Controller 114 can further determine the trend of the data over a new or subsequent production period following a clean-in-place cleaning period to provide a post-cleaning trend. Controller 114 can compare the post-cleaning trend to the determined trend (e.g., by comparing the slope of the data for the production period before the clean-in-place cleaning to the slope of the data for the production period after the clean-in-place cleaning). Controller can determine a quality of a clean-in-place cleaning associated with the clean-in-place cleaning period based on the comparison of the post-cleaning trend to the determined trend. For example, if the slope of the data for the production period after the clean-in-place cleaning has changed more than a threshold amount compared to the slope of the data for the production period before the clean-in-place cleaning, controller 114 may determine that the clean-in-place cleaning was not sufficiently effective. Various actions that may be taken in response to the determination can include modifying at least one process parameter or chemistry used during a subsequent clean-in-place cleaning period based on the determined quality of the clean-in-place cleaning.

As another example, controller 114 may project forward a determined trend for a parameter indicative of the flow of permeate and/or retentate to determine when membrane 102 will reach the end of its service life. Since progressive cleanings of membrane 102, including deep cleanings, yield diminishing performance improvements over time, controller 114 can determine when capacity loss of membrane 102 is predicted to be realized notwithstanding further cleaning. Controller 114 may inform a user if and/or when a replacement membrane should be installed, e.g., including a number of days corresponding to a time safety margin before capacity loss is expected to be realized.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components. For example, features described as controllers herein such as controller 114 using computing hardware physically co-located with membrane 102 or may be partially or fully physically remote from the membrane, such as implemented through a remote server, cloud-computing environment, or other physically remote computing device.

The techniques described in this disclosure may also be embodied or encoded in a computer-readable medium, such as a non-transitory computer-readable storage medium, containing instructions. Instructions embedded or encoded in a computer-readable storage medium may cause a programmable processor, or other processor, to perform the method, e.g., when the instructions are executed. Non-transitory computer readable storage media may include volatile and/or non-volatile memory forms including, e.g., random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A method comprising:
contacting a membrane with a feed stream during each of a plurality of production periods, thereby generating a permeate stream and a retentate stream;
performing a clean-in-place cleaning of the membrane during each of a plurality of clean-in-place cleaning periods, wherein each of the plurality of production periods are separated by one of the plurality of clean-in-place cleaning periods;
receiving, by one or more processors, data indicative of a flow of one or both of the permeate stream and the retentate stream during the plurality of production periods;
determining, by one or more processors, a trend of at least one parameter indicative of the flow of one or both of the permeate stream and the retentate stream during the plurality of production periods to provide a determined trend;
determining, by one or more processors, a time to perform a deep cleaning on the membrane based on the determined trend; and
subsequently performing the deep cleaning on the membrane.

2. The method of claim 1, wherein determining, by one or more processors, the time to perform the deep cleaning on the membrane based on the determined trend comprises determining, by one or more processors, the time to perform the deep cleaning on the membrane based on extrapolation of the determined trend.

3. The method of claim 2, wherein determining, by one or more processors, the time to perform the deep cleaning on the membrane based on the determined trend comprises:
extrapolating, by one or more processors, the determined trend and determining, by the one or more processors, a predicted time when membrane production is expected to start dropping based on extrapolation of the determined trend; and
determining, by the one or more processors, the time to perform the deep cleaning by applying a time safety margin offset to the predicted time when membrane production is expected to start dropping.

4. The method of claim 1, wherein the feed stream comprises a human-consumable food or beverage feedstock.

5. The method of claim 1, wherein:
receiving, by one or more processors, data indicative of the flow of one or both of the permeate stream and the retentate stream during the plurality of production periods comprises receiving, by one or more processors, data indicative of the flow of one or both of the permeate stream and the retentate stream during the plurality of production periods during an active phase of each of the plurality of production periods and an inactive phase of each of the plurality of production periods; and
determining, by one or more processors, the trend of at least one parameter indicative of the flow of one or both of the permeate stream and the retentate stream during the plurality of production periods to provide the determined trend comprises excluding data indicative of the flow during the inactive phase of each of the plurality of production periods and determining the trend based on the data indicative of the flow during the active phase of each of the plurality of production periods.

6. The method of claim 5, wherein a start of the active phase is determined based on an opening of a valve controlling a flow of the feed stream to the membrane and an opening of a valve controlling a flow of the retentate stream from the membrane, and a stop of the active phase is determined based on a closing of the valve controlling the flow of the feed stream to the membrane and/or a closing of the valve controlling the flow of the retentate stream from the membrane.

7. The method of claim 5, wherein determining the trend based on the data indicative of the flow during the active phase of each of the plurality of production periods comprises integrating a magnitude of the data indicative of the flow during the active phase of each of the plurality of production periods over time.

8. The method of claim 1, wherein performing the clean-in-place cleaning of the membrane during each of the plurality of clean-in-place cleaning periods comprises removing some but not all foulant buildup on the membrane such that an amount of foulant buildup increases over time prior to performing the deep cleaning.

9. The method of claim 1, wherein the at least one parameter indicative of the flow of one or both of the permeate stream and the retentate stream comprises one or more of a time-averaged permeate flow rate, a time-averaged retentate flow rate, a pressure and area-normalized permeate flow, a pressure and area-normalized retentate flow, an area normalized permeate flow, and an area normalized retentate flow.

10. The method of claim 1, wherein performing the deep cleaning on the membrane comprises controlling, by one or more processors, execution of the deep cleaning at the time.

11. The method of claim 1, further comprising:
extrapolating, by one or more processors, the determined trend and determining, by the one or more processors, a predicted time when membrane production is expected to start dropping based on extrapolation of the determined trend; and
determining, by the one or more processors, a time for replacement of the membrane that includes a time safety margin offset to the predicted time when membrane production is expected to start dropping.

12. The method of claim 1, wherein:
determining, by one or more processors, the trend of at least one parameter indicative of the flow of one or both of the permeate stream and the retentate stream during the plurality of production periods to provide the determined trend comprises (1) determining the trend of the at least one parameter over a prior plurality of production periods to provide the determined trend and (2) determining the trend of the at least one parameter over a new production period that follows a clean-in-place cleaning period to provide a post-cleaning trend;
comparing, by one or more processors, the post-cleaning trend to the determined trend; and
determining, by one or more processors, a quality of a clean-in-place cleaning associated with the clean-in-place cleaning period based on the comparison of the post-cleaning trend to the determined trend.

13. The method of claim 12, further comprising modifying at least one process parameter or chemistry used during a subsequent clean-in-place cleaning period based on the determined quality of the clean-in-place cleaning.

14. The method of claim 12, wherein comparing, by one or more processors, the post-cleaning trend to the determined trend comprises comparing a slope of a curve of the post-cleaning trend to a slope of a curve of the determined trend.

15. The method of claim 1, wherein performing the clean-in-place cleaning of the membrane comprises:
pre-rinsing the membrane with a pre-rinse fluid;
cleaning the membrane with a cleaning fluid; and
post-rinsing the membrane with a post-rinse fluid.

16. The method of claim 1, wherein determining, by one or more processors, the trend of the at least one parameter indicative of the flow of one or both of the permeate stream and the retentate stream during the plurality of production periods comprises fitting a curve to the at least one parameter over a time of the plurality of production periods.

17. A system comprising:
a membrane configured to receive a feed stream during each of a plurality of production periods and generate a permeate stream and a retentate stream;
a clean-in-place system operable to perform a clean-in-place cleaning of the membrane during each of a plurality of clean-in-place cleaning periods, wherein each of the plurality of production periods are separated by one of the plurality of clean-in-place cleaning periods;
one or more sensors configured to generate data indicative of a flow of one or both of the permeate stream and the retentate stream during the plurality of production periods; and
a controller communicatively coupled to the one or more sensors and configured to:
determine a trend of at least one parameter indicative of the flow of one or both of the permeate stream and the retentate stream during the plurality of production periods to provide a determined trend; and
determine a time to perform a deep cleaning on the membrane based on the determined trend.

18. The system of claim 17, wherein the controller is configured to determine the time to perform the deep cleaning on the membrane based on the determined trend by at least extrapolating the determined trend.

19. The system of claim 18, wherein the controller is configured to determine the time to perform the deep cleaning on the membrane based on the determined trend by at least:
extrapolating the determined trend and determining a predicted time when membrane production is expected to start dropping based on extrapolation of the determined trend; and
determining the time to perform the deep cleaning by applying a time safety margin offset to the predicted time when membrane production is expected to start dropping.

20. The system of claim 17, wherein the controller is configured to:
receive data indicative of the flow of one or both of the permeate stream and the retentate stream during the plurality of production periods during an active phase of each of the plurality of production periods and an inactive phase of each of the plurality of production periods; and
determine the trend of at least one parameter indicative of the flow of one or both of the permeate stream and the retentate stream by at least excluding data indicative of the flow during the inactive phase of each of the plurality of production periods and determining the trend based on the data indicative of the flow during the active phase of each of the plurality of production periods.
